(19) United States
(12) Patent Application Publication
(10) Pub. No.: US 2014/0046525 A1
(43) Pub. Date: Feb. 13, 2014

(54) START CONTROL APPARATUS AND METHOD FOR A HYBRID ELECTRIC VEHICLE

(71) Applicants: HYUNDAI MOTOR COMPANY, Seoul (KR); KIA MOTORS CORPORATION, Seoul (KR)

(72) Inventors: Hee Ra Lee, Anyang (KR); Ki Nam Kim, Seongnam (KR); Yeonho Kim, Suwon (KR); Sanghyun Jeong, Hwaseong (KR)

(73) Assignees: KIA MOTORS CORPORATION, Seoul (KR); HYUNDAI MOTOR COMPANY, Seoul (KR)

(21) Appl. No.: 13/717,344

(22) Filed: Dec. 17, 2012

(30) Foreign Application Priority Data
Aug. 9, 2012 (KR) 10-2012-0087270

(51) Int. Cl. B60W 10/10; B60W 20/00

(52) U.S. Cl. CPC B60W 10/10; B60W 20/00; Y10S 903/945
USPC 701/22; 903/945; 180/65.27

(57) ABSTRACT

Disclosed is a start control apparatus and method for a hybrid electric vehicle which provides starting of a second gear ratio or a first ratio based on an inclination of a road surface, a travel environment, and a state of the vehicle when the hybrid electric vehicle stops and then starts. The method includes: determining a state of the hybrid electric vehicle, a travel environment condition, and a state of charge (SOC) of a battery when a start request is detected in a stopped state while the vehicle maintains ignition on; determining whether the state of the hybrid electric vehicle, the travel environment condition, and the SOC of the battery satisfy start conditions of a second gear ratio; and when the start conditions are satisfied, controlling output torques of a motor and an engine corresponding to a torque requested from an accelerator pedal in an EV mode or an HEV mode.

### CROSS-REFERENCE TO RELATED APPLICATION

This application claims priority to and the benefit of Korean Patent Application No. 10-2012-0087270 filed in the Korean Intellectual Property Office on Aug. 9, 2012, the entire contents of which are incorporated herein by reference.

### BACKGROUND OF THE INVENTION

(a) Field of the Invention

The present invention relates to a start control apparatus and method for a hybrid electric vehicle, and more particularly, to a start control apparatus and method by which the vehicle is started using either a second gear ratio or a first gear ratio based on an inclination of a road surface, a travel environment, and a state of the vehicle when the hybrid electric vehicle is started after coming to a start.

(b) Description of the Related Art

In order to improve fuel consumption, satisfy On Board Diagnosis (OBD) regulations with respect to exhaust gas, and minimize use of fossil fuels, hybrid electric vehicles, fuel cell vehicles, and electric vehicles have been developed.

Hybrid electric vehicles provide an EV mode in which the vehicle is powered by a driving torque of only a motor, and an HEV mode in which the vehicle is powered by driving torques of the motor and an engine. The mode is generally selected according to a load of the vehicle and a State Of Charge (SOC) of a battery.

Typically, an automatic transmission or a CVT is applied to the hybrid electric vehicle. Further, the automatic transmission is operated by hydraulic pressure, and includes a plurality of friction elements which are locked or unlocked according to transmission control.

When the hybrid electric vehicle stops and then starts (i.e. comes to a stop followed by acceleration, such as stopping at a red light and then proceeding), the automatic transmission is operated as a first gearshift having a high gear ratio. This ensures that a great output torque is provided so as to restore a stop inertia force of the hybrid electric vehicle.

However, if the hybrid electric vehicle frequently starts on a planar road or in a condition where an inclination of a road surface is small, then starting through the high gear ratio may deteriorate efficiency of the automatic transmission. As a result, fuel consumption may be deteriorated. Experimental analysis indicates that start of the first gear ratio deteriorates the efficiency of the automatic transmission by average 2.5% and fuel consumption by 0.5% or greater as compared with start of the second gear ratio.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a start control apparatus of a hybrid electric vehicle that improves efficiency of an automatic transmission and fuel consumption by selectively performing start of a first gear ratio or a second gear ratio. In particular, according to the present invention, a first gear ratio or a second gear ratio is selected based on a plurality of conditions when the hybrid electric vehicle starts after stopping. According to various embodiments the plurality of conditions can include, for example, an inclination condition of a road surface and a state and a travel environment condition of the vehicle.

According to an embodiment of the present invention, there is provided a start control apparatus for a hybrid electric vehicle including an engine, a motor, and a transmission, the start control apparatus comprising: an operation information detector for detecting information with respect to the state of the vehicle, and environmental information with respect to a travel region of the vehicle; a battery manager for detecting voltages, currents, and temperatures of respective cells of the vehicle battery, and for managing a state of charge (SOC) of the battery; and a controller for analyzing the detected information with respect to the state of the vehicle, the environmental information, and the SOC of the battery, and for executing start control by selectively shifting a gearshift of the transmission to a first gear ratio or a second gear ratio when the vehicle stops and then starts.

According to various aspects, the operation information detector may include: a vehicle speed detector for detecting travel speed; an Acceleration Pedal Position Sensor (APS) for detecting a location of an accelerator pedal; a Brake Position Sensor (BPS) for detecting a location of a brake pedal and a force applied to the pedal; a gearshift detector for detecting a location of a gearshift selected by a shift lever; an inclination detector for detecting an inclination of a road surface; and an outside air temperature detector for detecting a temperature of air outside the vehicle.

The controller may control starting of the vehicle by shifting the gearshift of the transmission to the first gear ratio of the second gear ratio based on information detected with respect to the inclination of the road surface, a state of the vehicle, and an environmental condition when a shift lever performs N→D shift of in a stopped state of the vehicle.

In a case where the shift lever performs the N→D shift in the stopped state of the vehicle during analysis of a state, when (a) the inclination of the road surface is equal to or less than a reference inclination and (b) the temperature of the outside of the vehicle is equal to or greater than a reference temperature in analysis of an environment condition, and (c) the SOC of the battery provided from the battery manager is equal to or greater than a reference amount, then the controller may control the start of the vehicle by shifting the gearshift of the transmission to the second gear ratio. In a case of controlling the start of the vehicle by shifting the gearshift of the transmission to the second gear ratio, when a driving torque greater than a driving torque requested from an accelerator pedal is required, the controller may control the start of the vehicle by shifting the gearshift of the transmission to the first gear ratio. In a case where the shift lever performs the N→D shift in the stopped state of the vehicle, when the inclination of the road surface, the outside air of the vehicle, the SOC of the battery, and the vehicle load satisfy predetermined start conditions of the second gear ratio, then the controller may control the start of the vehicle by shifting the gearshift of the transmission to the second gear ratio. In a case where the shift lever performs the N→D shift in the stopped state of the vehicle, when at least one of the inclination of the road surface, the temperature of the outside air of the vehicle, the SOC of the battery, and the vehicle load do not satisfy start conditions of the second gear ratio, then the controller may control the start of the vehicle by shifting the gearshift of the transmission to the first gear ratio.

According to various embodiments, then the shift lever performs the N→D shift in a stopped state of the vehicle, as start conditions of the second gear ratio, the inclination of the road surface may be equal to or less than maximum inclination that the vehicle can be climbed by the second gear ratio, the SOC of the battery may be in a state sufficient for operating the motor, and the temperature of the outside air of the vehicle may be not very low. For example, an outside air temperature which may be considered “not very low” could include temperatures not lower than about −30° C., for example, temperatures between about −30° C. to −10° C. might be considered as not very low.

According to an embodiment of the present invention, there is provided a method of controlling the starting of a hybrid electric vehicle executed by a processor within a controller installed within the hybrid vehicle. More specifically, this method includes: determining a state of the hybrid electric vehicle, a travel environment condition, and a state of charge (SOC) of a battery when the vehicle is in a stopped state while maintaining ignition on (e.g. when stopping in traffic or at a red light by depressing the brake pedal), and a start request is detected (e.g. a driver releases the brake pedal and presses the accelerator); determining whether the state of the hybrid electric vehicle, the travel environment condition, and the SOC of the battery satisfy predetermined start conditions of a second gear ratio; and when the state of the hybrid electric vehicle, the travel environment condition, and the SOC of the battery satisfy the start conditions of a second gear ratio, controlling output torques of the motor and the engine corresponding to a torque requested from an accelerator pedal in an EV mode or an HEV mode. The state of the hybrid electric vehicle may include, for example, N→D (neutral→drive) shift information of a shift lever and a vehicle load condition. The travel environment conditions can include, for example, the inclination of the road surface and the temperature of air outside the vehicle. When at least one of the state of the hybrid electric vehicle, the travel environment conditions, and the SOC of the battery does not satisfy the start conditions of the second gear ratio, then the gearshift of the transmission may be controlled to shift to the first gear ratio, and the output torques of the motor and the engine may be controlled so as to correspond to the torque requested from the accelerator pedal in the EV mode or the HEV mode.

According to various embodiments, when the torques of the motor and the engine do not ensure a start driving torque of the second gear ratio corresponding to a requested torque in a state that the start of the hybrid electric vehicle is executed as the second gear ratio, then the start may be controlled so that the start of the hybrid electric vehicle is executed at the first gear ratio.

According to another embodiment of the present invention, there is provided a method of controlling starting of a hybrid electric vehicle executed by a processor within a controller installed within the hybrid vehicle. More specifically, this method includes: detecting an inclination of a road surface, a temperature of air outside the vehicle, and a state of charge (SOC) of a battery when a N→D shift is detected in a state in which the hybrid electric vehicle is stopped while maintaining ignition on; determining whether the inclination, the temperature of air outside the vehicle, and the SOC of the battery satisfy start conditions of a second gear ratio when the N→D shift is detected in a stopped state while maintaining ignition; and controlling start of the vehicle so that a gearshift of a transmission is shifted to the second gear ratio when the inclination, the temperature of the air outside the vehicle, and the SOC of the battery satisfy the start conditions of the second gear ratio.

According to various aspects, the method of controlling start of a hybrid electric vehicle may further include: when controlling start so that the gearshift of the transmission is shifted to the second gear ratio, controlling output torques of the motor and engine corresponding to a torque requested from an accelerator pedal in an EV mode or an HEV mode; and when the output torques of the motor and the engine do not correspond to a torque requested from an accelerator pedal, controlling the start so that the gearshift of the transmission is shifted to the first gear ratio.

According to various embodiments, as the start conditions of the second gear ratio, the inclination of the road surface may be set to less than or equal to a reference inclination, the temperature of the outside air of the vehicle may be set to equal to or greater than a preset temperature, and the SOC of the battery may be set to equal to or greater than a predetermined amount. When at least one of the inclination, the temperature of air outside the vehicle, and the SOC of the battery does not satisfy the start conditions of the second gear ratio, the start of the vehicle may be controlled so that the gearshift of the transmission is shifted to the first gear ratio.

As described above, according to embodiments of the present invention, when the hybrid electric vehicle stops and then starts, by selectively performing start of the first gear ratio or the second gear ratio, the efficiency of the automatic transmission and the fuel consumption can be improved.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a diagram schematically illustrating a start control apparatus of a hybrid electric vehicle according to an exemplary embodiment of the present invention.

FIG. 2 is a flowchart illustrating a start control method of a hybrid electric vehicle according to an exemplary embodiment of the present invention.

### DESCRIPTION OF SYMBOLS

| | |
|---|---|
| 110: operation information detector | 120: controller |
| 130: inverter | 150: battery manager |
| 160: engine | 180: motor |
| 200: transmission | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, the present invention will be described more fully hereinafter with reference to the accompanying drawings, in which exemplary embodiments of the invention are shown.

However, the present invention may be modified in various different ways, not limited to the exemplary embodiment described herein.

Parts irrelevant to a description are omitted to clearly illustrate the present invention, and like reference numbers designate like constituent elements through the specification.

Further, the size and thickness of each configuration shown in the drawings are optionally illustrated for better understanding and ease of description, the present invention is not limited to shown drawings.

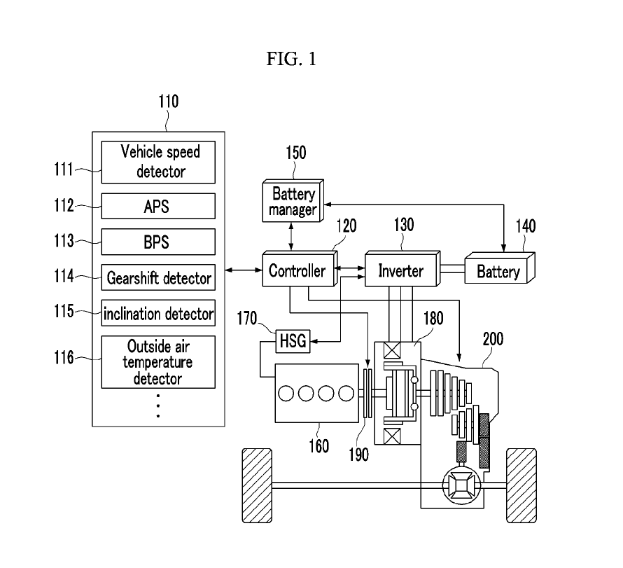

FIG. 1 is a diagram schematically illustrating a start control apparatus of a hybrid electric vehicle according to an exemplary embodiment of the present invention.

As shown in FIG. 1, the start control apparatus of a hybrid electric vehicle according to an exemplary embodiment of the present invention includes an operation information detector 110, a controller 120, an inverter 130, a battery 140, a battery manager 150, an engine 160, a Hybrid Starter and Generator (HSG) 170, a motor 180, an engine clutch 190, and a transmission 200.

As shown, the operation information detector 110 is configured to detect information with respect to the state of the vehicle, such as vehicle speed, a state of a brake pedal, a state of an accelerator pedal, and a location of a gearshift. The operation information detector 110 is further configured to detect information with respect to the environment in which the vehicle is travelling, such as an inclination of the road and a temperature of air outside the vehicle. The operation information detector 110 provides the detected information to the controller 120.

For example, as shown in FIG. 1, the operation information detector 110 can include a vehicle speed detector 111, an Acceleration Pedal Position Sensor (APS) 112, a Brake Position Sensor (BPS) 113, a gearshift detector 114, an inclination detector 115, and an outside air temperature detector 116.

The vehicle speed detector 111 is configured to detect travel speed, and provide the travel speed information to the controller 120 as an electric signal. Based on the information provided, the controller 120 may determine a travel state or a stop state.

The APS 112 is configured to detect the location of an accelerator pedal according to the angle (“tip in/out”) of the accelerator pedal, and provides information about the location of the accelerator pedal to the controller 120 as an electric signal. Based on the information provided by the APS 112, the controller 120 may determine a requested torque by a driver.

The BPS 113 is configured to detect a pedal force based on the operation of the brake pedal and a depth to which the brake pedal has been pressed, and provides information about the brake pedal to the controller 120 as an electric signal. Based on the information provided by the BPS 113, the controller 120 may determine whether the driver intends to stop or start the vehicle.

The gearshift detector 114 is configured to detect a location of a gearshift selected by a shift lever, and provides information about the selected location of the gearshift to the controller 120.

The inclination detector 115 includes an inclination angle sensor, and is configured to detect an inclination of a traveled road surface, and provides information about the inclination to the controller 120.

The outside air temperature detector 116 is configured to detect a temperature of air outside the vehicle in a traveled region, and provides information about the temperature of the outside air to the controller 120.

The controller 120 is configured to determine an inclination condition of the road surface and a driving torque securing condition when the vehicle is in a stopped state. Based on the detected inclination condition and the driving torque, the controller allows a gearshift of the transmission 200 to be shifted to the second gear ratio when the vehicle starts.

When the vehicle stops and then starts so that the gearshift of the transmission 200 is controlled to be shifted to the second gear ratio, the controller 120 controls engine 160 and motor 180 outputs. In particular, the controller 120 controls engine 160 and motor 180 outputs so that a driving torque during a starting point of the vehicle is stably ensured based on operation of an accelerator pedal as detected by the operation information detector 110.

When the vehicle stops and then starts, if the gearshift of the transmission 200 is controlled to be shifted to the second gear ratio, then the controller 120 determines a torque that should be requested of the driver and an actual torque requested by the driver. Further, if it is determined that a driving torque is greater than an intention of the driver, then the controller 120 shifts the gear shift of the transmission 200 to the first gear ratio.

When a sufficient driving torque capable of starting with a second gear ratio according to an output of the engine 160 or the motor 180 corresponding to the requested torque of the driver detected from the accelerator pedal is not ensured, the controller 120 controls shifting of the gearshift of the transmission from the second gear ratio to the first gear ratio. Accordingly, the controller 120 prevents a deterioration in climbing performance of the vehicle.

According to various embodiments, only when an inclination condition of the road surface, a state of the vehicle, and environmental conditions satisfy a start condition of a second gear ratio, does the controller 120 control the start of the vehicle by shifting the gearshift of the transmission 200 to the second gear ratio.

For example, as a start condition of the second gear ratio, the controller 120 may set an inclination of the road surface to be 8% or less. If the inclination of the road surface is 8% or greater, then the controller 120 controls the vehicle to start as a gearshift of a first gear ratio. If the inclination of the road surface is less than 8%, then the controller 120 controls the vehicle to start as a gearshift of a second gear ratio.

Of course, setting an inclination condition of the road surface to 8% is merely one exemplary embodiment, and various other inclination conditions may be set according to an output torque determined by driving the motor and the engine.

Further, when an SOC of the battery 140 is equal to or greater than a preset ratio, and a vehicle load is less than or equal to a preset amount e, then the controller 120 can be configured to control start of the vehicle as a gearshift of the second gear ratio.

According to various embodiments, the SOC of the battery 140 may be determined according to information provided from the battery manager 150. Further, a preset ratio of the SOC may be set to a suitable ratio, such as, for example about 45%.

Further, according to various embodiments, the controller 120 is configured to control start of the vehicle as a gearshift of the second gear ratio only when a temperature of air outside the vehicle is equal to or greater than a preset temperature.

Thus, in a case where the vehicle starts and then stops, if all of the predetermined conditions with respect to inclination of the road surface, the SOC of the battery 140, the temperature of air outside the vehicle, and the vehicle load are satisfied, then the controller 120 controls start of the vehicle as the gearshift of a second gear ratio.

For example, when the inclination of the road surface is 8% or less, the SOC of the battery is 45% or greater, the temperature of the outside air of the vehicle is not very low (e.g. no less than about −10° C. to about −30° C.), and the vehicle load is less than or equal to a preset amount, then the controller 120 controls the start of the vehicle as a gearshift of a second gear ratio.

However, if one or more of the foregoing conditions is not satisfied, then the controller 120 determines that the vehicle may not start as the gearshift of the second gear ratio, and instead controls the start of the vehicle as a gearshift of the first gear ratio.

According to various embodiments, the controller 120 may be configured to receive inclination information of the road surface from an inclination sensor provided inside or outside the vehicle. Moreover, the controller 120 may be configured to calculate a torque condition, such as longitudinal acceleration, to determine the inclination of the road surface.

According to various embodiments, an inverter 130 is provided and configured to convert a DC high voltage supplied from the battery 140 into a 3 phase AC voltage, and supplies the converted 3 phase AC voltage to the motor 180 under control of the controller 120. In addition, the AC voltage supplied to the motor 180 can be used as a driving voltage of the motor 180.

According to various embodiments, the inverter 130 can include a plurality of power switching devices, and each power switching device may be configured by one of an Insulated Gate Bipolar Transistor (IGBT), an MOSFET, and a transistor.

According to various embodiments, the battery 140 includes a plurality of unit cells, and a high voltage for providing a driving voltage to the motor 180 is stored in the battery 140. For example, the high voltage may be a voltage in the range of DC 350V to 450V.

The battery manager 150 can be configured to detect currents, voltages, and temperatures of respective cells in an operation range of the battery 140 to thereby manage the SOC. Furthermore, the battery manager 150 can be configured to control charge and discharge voltages of the battery 140 to prevent a life of the battery 140 from being reduced due to over-discharge less than a limited voltage or over-charge greater than a limited voltage.

The battery manager 150 can be configured to provide SOC information of the battery 140 to the controller 120 so that drive control of the motor 180 and regeneration power control are performed.

Further, starting on/off and an output are controlled by the controller 120, and an amount of intake air can be adjusted through Electric Throttle Control (ETC), which is not illustrated in the engine 160.

According to various embodiments, the HSG 170 is the first motor/generator, and is configured so as to operate as a motor under the control of the controller 120 to perform starting-on of the engine 160. In a state that the engine 160 maintains starting-on, the HSG 170 can be configured to operate as a generator and provide a generated voltage to the battery 140 through the inverter 130 as a charge voltage.

The motor 180 can be provided as the second motor/generator. In particular, the motor 180 can be configured to operate as a motor according to the 3 phase Ac voltage from the inverter 130 to generate a driving torque. The motor 180 can, thus, operate as a generator while the vehicle is coasting thereby generating regeneration energy and charging the battery 140.

As shown in FIG. 1, the engine clutch 190 is disposed between the engine 160 and the motor 180, and can be configured to connect or block power of the engine 160 and the motor 180 under the control of the controller 120 by switch between an EV mode and an HEV mode.

An engagement side friction element and a release side friction element of the transmission 200 may further be provided and configured to operate by hydraulic pressure according to a control signal from the controller 120 so that a gear ratio is adjusted.

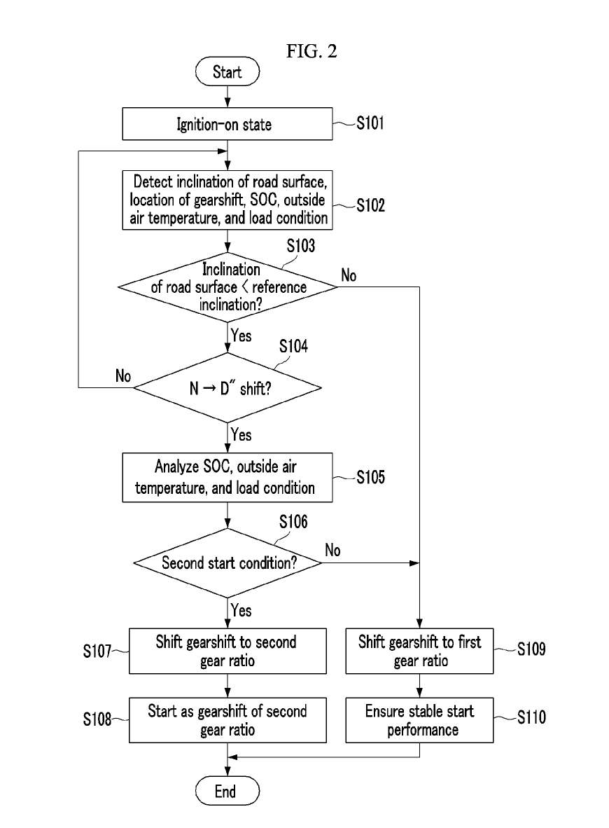

Hereinafter, a start control method of a hybrid vehicle according to an exemplary embodiment of the present invention will be described with reference to FIG. 2.

FIG. 2 is a flowchart illustrating a start control method of a hybrid electric vehicle according to an exemplary embodiment of the present invention.

In a state that a hybrid electric vehicle according to the present invention stops while maintaining ignition-on (S101), the controller 120 detects information including vehicle speed, a state of a brake pedal, a state of an accelerator pedal, and a location of a gearshift for determining a state of the vehicle, and information including an inclination of a road surface and a temperature of air outside the vehicle for determining an environment of a travel region from the operation information detector 110. Further, the controller 120 detects an SOC for determining a state of the battery 140 from the battery manager 150 (S102).

The controller 120 may, for example, detect the inclination of the road surface by an inclination sensor or may determine the inclination of the road surface by calculating the vehicle speed and other torque conditions received from a longitudinal acceleration sensor.

Next, the controller 120 determines whether the inclination of the road surface of a travel region is less than a predetermined inclination (S103).

The predetermined inclination may be set, for example, to 8%, and the engine 160 and the predetermined inclination may be variously changed according to an output torque of the motor 180.

If the inclination of the road is the predetermined inclination in step S103, then the controller 120 shifts a gearshift of the transmission 200 as a first gear ratio so that a high driving torque may be ensured (S109).

The controller 120 then controls torques of the motor 180 and the engine 160 corresponding to a start intention of a driver based on the driver's manipulation of an accelerator pedal. Further, the torques of the motor 180 and the engine 160 are controlled in an EV mode or an HEV mode to represent optimal efficiency. Accordingly, when the vehicle starts from a stopped state on an inclined road, stable start performance may be ensured (S110).

If the inclination of the road is less than or equal to the predetermined inclination in S103, then the controller 120 determines whether “N→D” shift of a shift lever is detected (S104).

If the “N→D” shift of the shift lever is detected in S104, then the controller 120 analyzes a temperature of air outside the vehicle and a vehicle load condition of a travel region received from the operation information detector 110. The controller 120 further analyzes the SOC of the battery 140 received from the battery manager 150 (S105).

Subsequently, the controller 120 determines whether the SOC of the battery 140, the temperature of air outside the vehicle, and the vehicle load condition analyzed in step S105 satisfy conditions in which the vehicle may start as a gearshift of the second gear ratio (S106).

If one or more of the SOC of the battery 140, the temperature of outside air of the vehicle, and the vehicle load conditions do not satisfy the predetermined start conditions of the second gear ratio in S106, then the controller 120 shifts the gearshift of the transmission 200 to the first gear ratio so that a high driving torque may be ensured (S109).

Next, the controller 120 controls torques of the motor 180 and the engine 160 corresponding to a start intention of the driver, which is determined based on the driver's manipulation of an accelerator pedal. Further, the torques of the motor 180 and the engine 160 are controlled to represent optimal efficiency in an EV mode or an HEV mode. Accordingly, when the vehicle starts in a stopped state on an inclined road, stable start performance may be ensured (S110).

According to the present invention, the controller 120 determines that start conditions of the second gear ratio are satisfied only when all of the SOC, the temperature of the air outside the vehicle, and a vehicle load condition satisfy the start conditions of the second gear ratio in step S106.

In particular, when the SOC of the battery 140 is equal to or greater than a preset ratio, the temperature of the air outside the vehicle is equal to or greater than a preset temperature, and the vehicle load is less than or equal or a preset amount in a state in which an inclination condition of the road surface satisfies the start conditions of the second gear ratio, then the controller 120 starts the vehicle as the second gear ratio.

If the start conditions of the second gear ratio in step S106 are met, then the controller 120 shifts the gearshift of the transmission 200 to the second gear ratio (S107), and controls the torques of the motor 180 and the engine 160 corresponding to the start intention of the driver requested through the accelerator pedal. In addition, the torques of the motor 180 and the engine 160 are controlled so that optimal efficiency is provided in the EV mode or the HEV mode. Accordingly, the vehicle is started as the gearshift of the second gear ratio in a stopped state on the inclined road (S108).

Further, an output torque of the motor 180 is controlled by the inverter 130, and the torques of the engine 160 and the motor 180 are controlled to represent optimal efficiency in the EV mode and the HEV mode so that start performance having optimal efficiency may be provided.

That is, only when the inclination condition of the road surface satisfies the start condition of the second gear ratio, the environmental condition of the vehicle satisfies the start condition of the second gear ratio, will the controller 120 control the start of the vehicle by shifting the gearshift of the transmission 200 to the second gear ratio.

Further, even if the inclination condition of the road surface satisfies the start condition of the second gear ratio, when a torque having a great load condition is required, the controller 120 shifts the gearshift of the transmission 200 to the first gear ratio.

Further, when an output of the engine 160 or motor 180 corresponding to a requested torque of the driver detected through the accelerator pedal does not ensure a sufficient driving torque in the second gear ratio, then the controller 120 prevents a deterioration in climbing performance of the vehicle by shifting a gearshift of the transmission 200 from the second gear ratio to the first gear ratio.

For example, when the SOC of the battery 140 is 45% or less, the temperature of the air outside the vehicle is a preset temperature or lower, or the vehicle load is a preset amount or greater, because start drivability may not be ensured as the second gear ratio, the controller 120 starts the vehicle as the gearshift of the first gear ratio.

As described above, in the hybrid vehicle to which an exemplary embodiment of the present invention is applied, when stopping and then starting is requested, an inclination condition and an environmental condition of a road and a state of the vehicle are analyzed. If start drivability may be ensured, the present invention controls start by shifting a gearshift to the second gear ratio. If start drivability may not be ensured, the present invention controls the start by shifting the gearshift to the first gear ratio which is the same or similar to general control.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A start control apparatus of a hybrid electric vehicle including an engine, a motor, and a transmission, the start control apparatus comprising:
an operation information detector for detecting vehicle state information and environmental information of a travel region of the vehicle;
a battery manager for detecting voltages, currents, and temperatures of respective cells constituting a battery and for managing a state of charge (SOC) of the battery; and
a controller for analyzing the vehicle state information and the environmental information detected by the operation information detector, and the SOC of the battery detected by the battery manager, and for executing start control by selectively shifting a gearshift of the transmission to a first gear ratio or a second gear ratio when the vehicle stops and then starts.

2. The start control apparatus of a hybrid electric vehicle of claim 1, wherein the operation information detector comprises:
a vehicle speed detector for detecting travel speed;
an Acceleration Pedal Position Sensor (APS) for detecting a location of an accelerator pedal;
a Brake Position Sensor (BPS) for detecting a location of a brake pedal and a pedal force;
a gearshift detector for detecting a location of a gearshift selected by a shift lever;
an inclination detector for detecting an inclination of a road surface; and
an outside air temperature detector for detecting a temperature of air outside the vehicle.

3. The start control apparatus of a hybrid electric vehicle of claim 2, wherein the controller controls start of the vehicle by shifting the gearshift of the transmission to the first gear ratio or the second gear ratio based on the inclination of the road surface, the vehicle state information, and the environmental information when a shift lever is shifted from neutral to drive in a stopped state of the vehicle.

4. The start control apparatus of a hybrid electric vehicle of claim 3, wherein in a case where the shift lever is shifted from neutral to drive in the stopped state of the vehicle during determination in of a state of the vehicle,
when the inclination of the road surface is equal to or less than a predetermined reference inclination, the temperature of the air outside the vehicle is equal to or greater than a predetermined reference temperature, and the SOC of the battery provided from the battery manager is equal to or greater than a predetermined reference amount, then the controller controls the start of the vehicle by shifting the gearshift of the transmission to the second gear ratio.

5. The start control apparatus of a hybrid electric vehicle of claim 3, wherein in a case of controlling the start of the vehicle by shifting the gearshift of the transmission to the second gear ratio, when a driving torque greater than a driving torque requested from an accelerator pedal is required, the controller controls the start of the vehicle by shifting the gearshift of the transmission to the first gear ratio.

6. The start control apparatus of a hybrid electric vehicle of claim 3, wherein in a case where the shift lever is shifted from neutral to drive in the stopped state of the vehicle, when the inclination of the road surface, the air outside the vehicle, the SOC of the battery, and the vehicle load satisfy predetermined start conditions of the second gear ratio, the controller controls the start of the vehicle by shifting the gearshift of the transmission to the second gear ratio.

7. The start control apparatus of a hybrid electric vehicle of claim 3, wherein in a case where the shift lever is shifted from neutral to drive in the stopped state of the vehicle, when one or more of the inclination of the road surface, the temperature of the air outside the vehicle, the SOC of the battery, and the vehicle load does not satisfy a start condition of the second gear ratio, the controller controls the start of the vehicle by shifting the gearshift of the transmission to the first gear ratio.

8. The start control apparatus of a hybrid electric vehicle of claim 3, wherein when the shift lever is shifted from neutral to drive in a stopped state of the vehicle, start conditions of the second gear ratio include the inclination of the road surface equal to or less than a maximum inclination that the vehicle can be climbed by the second gear ratio, a SOC of the battery sufficient to operate the motor, and a temperature of the air outside the vehicle is set to be not less than about −10° C. to about −30° C.

9. A method of controlling start of a hybrid electric vehicle executed by a processor within a controller, the method comprising:
when the hybrid electric vehicle is in a stopped state while maintaining ignition on and a start request is detected, determining a state of the hybrid electric vehicle, a travel environment condition, and a state of charge (SOC) of a battery;
determining whether the state of the hybrid electric vehicle, the travel environment condition, and the SOC of the battery satisfy predetermined start conditions of a second gear ratio; and
when the state of the hybrid electric vehicle, the travel environment condition, and the SOC of the battery satisfy the predetermined start conditions of the second gear ratio, controlling output torques of a motor and an engine corresponding to a torque requested from an accelerator pedal in an EV mode or an HEV mode.

10. The method of claim 9, wherein the state of the hybrid electric vehicle comprises neutral to drive shift information of a shift lever and a vehicle load condition, and the travel environment condition comprises the inclination of the road surface and a temperature condition of air outside the vehicle.

11. The method of claim 9, wherein when at least one of the state of the hybrid electric vehicle, the travel environment condition, and the SOC of the battery does not satisfy the predetermined start conditions of the second gear ratio, shifting the gearshift of the transmission to the first gear ratio, and controlling the output torques of the motor and the engine corresponding to the torque requested from the accelerator pedal in the EV mode or the HEV mode.

12. The method of claim 9, wherein when the torques of the motor and the engine do not ensure a start driving torque of the second gear ratio corresponding to a requested torque in a state that the start of the hybrid electric vehicle is executed as the second gear ratio, controlling the start so that the start of the hybrid electric vehicle is executed as the first gear ratio.

13. A method of controlling start of a hybrid electric vehicle executed by a processor within a controller, the method comprising:
when the hybrid electric vehicle is in a stopped state while maintaining ignition on, when a neutral to drive shift is detected, detecting an inclination of a road surface, a temperature of an outside air of the vehicle, and a state of charge (SOC) of a battery;
determining whether the inclination, the temperature of air outside the vehicle, and the SOC of the battery satisfy predetermined start conditions of a second gear ratio when the neutral to drive shift is detected in a stopped state while maintaining ignition; and
controlling start of the vehicle so that a gearshift of a transmission is shifted to the second gear ratio when the inclination, the temperature of the air outside the vehicle, and the SOC of the battery satisfy the start condition of the second gear ratio.

14. The method of claim 13, further comprising;
controlling output torques of a motor and an engine corresponding to a torque requested from an accelerator pedal in an EV mode or an HEV mode when controlling start so that the gearshift of the transmission is shifted to the second gear ratio; and
controlling the start so that the gearshift of the transmission is shifted to the first gear ratio when the output torques of the motor and the engine do not correspond to a torque requested from an accelerator pedal.

15. The method of claim 13, wherein as the start condition of the second gear ratio, the inclination of the road surface is set to less than or equal to a reference inclination, the temperature of the outside air of the vehicle is set to equal to or greater than a preset temperature, and the SOC of the battery is set to equal to or greater than a predetermined amount.

16. The method of claim 13, wherein when at least one of the inclination, the temperature of an outside air of the vehicle, and the SOC of the battery does not satisfy the start conditions of the second gear ratio, the start of the vehicle is controlled so that the gearshift of the transmission is shifted to the first gear ratio.

17. A non-transitory computer readable medium containing program instructions executed by a processor, the computer readable medium comprising:
program instructions that determine a state of the hybrid electric vehicle, a travel environment condition, and a state of charge (SOC) of a battery of the hybrid electric vehicle;
program instructions that determine whether the state of the hybrid electric vehicle, the travel environment condition, and the SOC of the battery satisfy predetermined start conditions of a second gear ratio; and
program instructions that control output torques of a motor and an engine corresponding to a torque requested from an accelerator pedal in an EV mode or an HEV mode when the predetermined start conditions are satisfied.
